(19) United States
(12) Patent Application Publication
(10) Pub. No.: US 2006/0031366 A1
(43) Pub. Date: Feb. 9, 2006

(54) Method for dynamically ordering instant messaging lists

(75) Inventor: Blaine H. Dolph, Western Springs, IL (US)

Correspondence Address: Darcell Walker;Suite 250, 9301 Southwest Freeway, Houston, TX, 77074, US

(73) Assignee: International Business Machines Corporation, Armonk, NY (US)

(21) Appl. No.: 10/849,607

(22) Filed: May 20, 2004

(51) Int. Cl. G06F 15/16

(52) U.S. Cl. 709/207

(57) ABSTRACT

The present invention provides a method that dynamically orders entries in an electronic list such as a ‘buddy list’. In this order, the most recently contacted and most frequently contacted entries in the list will be placed at the top of the list in descending order. The location of each entry in the list will contain a counter field. Each time the entry is accessed the count in that field for that entry will be incremented by one. At the completion of the transaction, the method of the present invention will determine if the transaction necessitates a reordering of the entries in the list. If a reordering is necessary, the method will reorder this list according the number of times the user has accessed each entry.

### FIELD OF THE INVENTION

The present invention relates to a method for dynamically ordering names included in an instant messaging list and in particular to a method for tracking the number of times each name in a list has been accessed by the list creator and ordering the names in the list in accordance to the number of times the creator has accessed that name.

### BACKGROUND OF THE INVENTION

E-mail is now a standard form of communication and information exchange. Telephone via the personal computer and shared collaboration are widely accepted and utilization of these modes are growing daily. A new form of communication, instant messaging, is also becoming prevalent as a private extension to chat groups and is in use by over ten million people today. Instant messaging (IM) is an Internet protocol (IP) based application that provides convenient communication between people using a variety of different device types. The most familiar today is computer-to-computer instant text messaging, but IM also can work with mobile devices, such as digital cellular phones, and can incorporate voice or video.

The millions of people using current Internet IM services and the growing popularity of short text messaging on mobile phones demonstrate that a market exists for IM services. Carriers can take advantage of this opportunity by offering advanced messaging services that integrate both fixed and mobile access and add new features that are not possible on free Web-based messaging services.

Instant messaging, once was the domain of teenagers who had found the high-tech equivalent to passing notes in class. They used the Internet and on-line services to chat from their computers. But with 600 million messages sent a day with America Online's messaging service alone, not to mention the other IM services such as MSN Messenger, Yahoo! Messenger, Lycos Instant Messenger and Lotus Sametime, use of this service has clearly moved to the mainstream as adults find messaging an easy, convenient way to communicate with friends, family, and colleagues with more immediacy than e-mail and without the expense of long-distance phone calls. Instant messaging allows end users to select “buddies” and assign these buddies to “buddy groups,” automatically register a person when on-line, advertise the user's selected buddies to the user when the selected buddies register on-line, advertise the user's presence on-line to others who have selected the user as a buddy, and participate in instant messaging communication between two on-line users.

Many developers provide proprietary software for enabling instant messaging between on-line users, including but not limited to America Online, General Magic, Inc., and Mirabilis. Standards are currently being developed to develop a uniform protocol for packaging and transporting instant messages. Such standardization will only serve to act as a catalyst to spur greater instant messaging use, new standard network servers, and new and improved client software.

As mentioned, instant messaging has become a very popular for of communication. In addition, IM has become a basic toll that people use to conduct business. Many users create “buddy lists” using this instant messaging technology. Some of theses buddy lists of contact can and have become very long (some lists contain hundreds of people). With the large number of users, the speed and efficiency of finding a particular person to communicate with is reduced and the task of locating the desired person is cumbersome and inefficient. There remains a need for a method to electronically store and access created lists of contacts known as ‘buddies’.

### SUMMARY OF THE INVENTION

It is an objective of the present invention to provide a method to dynamically arrange entries stored in an electronically created and maintained lists.

It is a second objective of the present invention to provide a method to dynamically order the entries in the electronically created list based on the number of times the creator or user of the list has accessed each entry.

It is a third objective of the present invention to provide a means to track each time the user has accessed each entry in the list.

It is a fourth objective of the present invention to provide a means to designate entries in the list that have static characteristics.

It is a fifth objective of the present invention to provide a method that establishes multiple statuses for list entries based on the amount of elapsed time between accesses for that entry.

The present invention provides a method that dynamically orders entries in an electronic list such as a ‘buddy list’. In this order, the most recently contacted and most frequently contacted entries in the list will be placed at the top of the list in descending order. The location of each entry in the list will contain a counter field. Each time the entry is accessed the count in that field for that entry will be incremented by one. The counter can also be incremented each time the list user receives a message. In this case, the entry corresponding to the person sending the message is incremented in the list. At the completion of the transaction, the method of the present invention will determine if the transaction necessitates a reordering of the entries in the list. If a reordering is necessary, the method will reorder this list according the number of times the user has accessed each entry.

In the present invention, each entry in the list can be classified as either ‘fixed’ or ‘dynamic’. The fixed entries will remain in list in a location that the user explicitly places them. The dynamic entries will be subject to the reordering method of the present invention. In the method of the present invention, each time the user sends a message to a person on the list, the entry for that person is incremented by one. If desired, the method of the present invention can also maintain a record of the last time a person was contacted by the user. With information, the entries in the list can also be sorted according the time of the contact. In that way, the entries that have been recently contacted will be placed at the top of the list. Therefore, if the user is working on a particular task with a particular person or group of people, the names of the persons with whom the user is currently working will be at the top of the list. As the amount of work with the person or persons is reduced, the person will fall in the list.

### BRIEF DESCRIPTION OF THE DRAWINGS

FIG. 1 depicts data processing equipment a system that can be utilized to implement the present invention.

FIG. 2 is a diagram of a computer network over which users can access persons located created lists.

FIG. 3 is an illustration of a typical network system in which an instant messaging buddy system can be implemented in accordance with the present invention.

FIG. 4 is a typical display screen in which a user will access a buddy list and a particular person on that list.

FIG. 5 is an illustration of a set of records corresponding to a set of persons that are included in a buddy list in accordance with one embodiment of the present invention.

FIG. 6 is an illustration of a set of records corresponding to a set of persons that are included in a buddy list showing fields for number of accesses and the time of the last access of that person in the list.

FIG. 7 is an illustration of a set of records corresponding to a set of persons that are included in a buddy list showing fields for number of accesses and the time of the last access of that person in the list.

FIG. 8 is an illustration of the main steps in the implementation of the method of the present invention.

FIG. 9 is an illustration of the steps in an alternate embodiment of the method of the present invention using time and transaction count to order the entries in a buddy list.

### DETAILED DESCRIPTION OF THE INVENTION

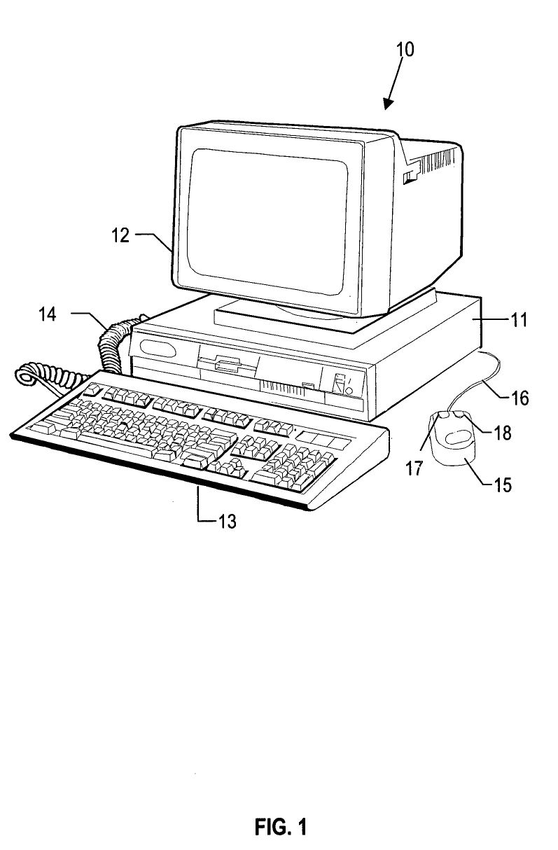

Electronic mail message transmissions occur over computing devices, usually personal computers, connected to a communication network. With reference now to FIG. 1, there is depicted a pictorial representation of computing device 10 which may be used in implementation of the present invention. Although the invention is described in terms of the device illustrated in FIG. 1, other types of electronic devices capable of transmitting and receiving information can be used in the implementation of the present invention. As seen in FIG. 1, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

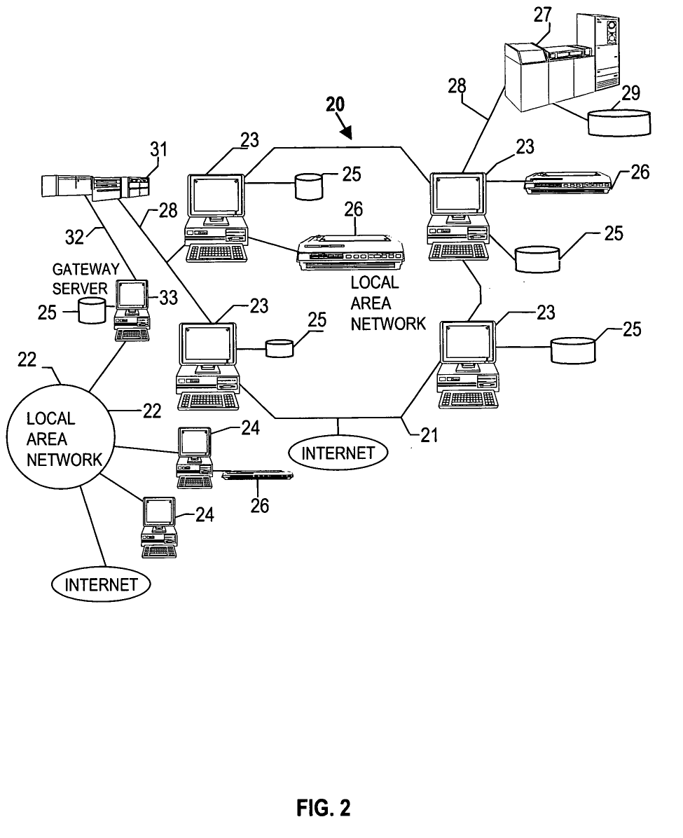

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

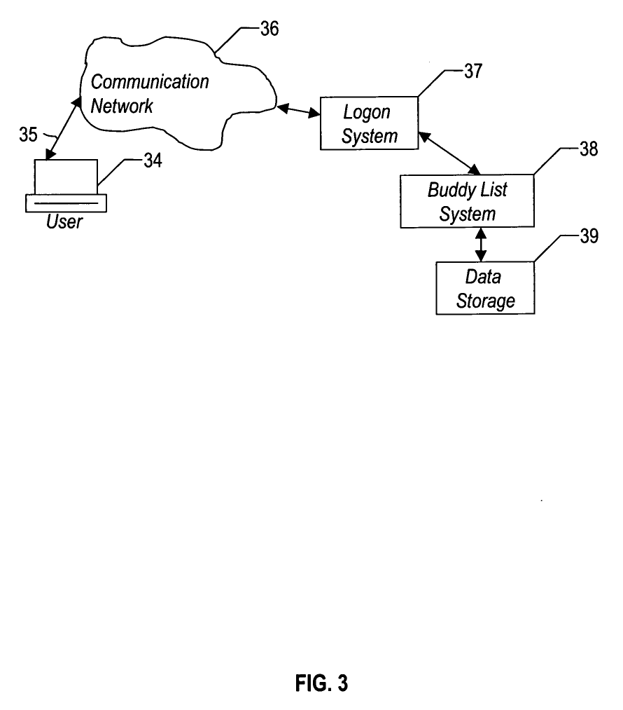

Referring to FIG. 3, shown in a diagram of a typical communication network over which an instant messaging buddy system can be implemented in accordance with the present invention. The network system includes a plurality of user stations 34 having a network link 35. The network link 35 is for receiving and transmitting data in analog or digital form over a communications network 36, such as the internet. The communications network 36 connects each user station 34 as a “client” to a logon system 35, which is typically a software program executing on a remote server somewhere on a network. The logon system 37 communicates with a “Buddy List System” 38, which is preferably a software program executing on a server somewhere on the network. The Buddy List System 38 maintains a database 39 for storing user information. The database 38 may be of any type, such as relational or hierarchical, and may be centralized or distributed. For example, the database 39 may be stored at least in part on each user's own station 34. In such a case, the database 39 contents would be transmitted to the Buddy List System 38 when the user logged into the system.

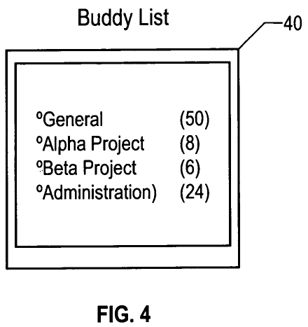

FIG. 4 is a typical display screen 40 in which a user will access a buddy list and a particular person on that list. As shown, a user can have multiple groups in the buddy list. Each group can display the number of entries currently contained in that group. In FIG. 4, this number of entries is adjacent each list name. A general group list can contain names of persons such as relatives, friends and acquaintances. The Alpha and Beta groups can contain persons related to work or business projects. Lastly, the administration group list can contain names of persons on a manager's staff or part of a project. In any case, when a user desires to contact a person on a group list, that user can first access the particular group. Once the list is displayed, the user can then identify a particular person/entry to contact. In the alternative, the user may desire to contact the entire list of entries.

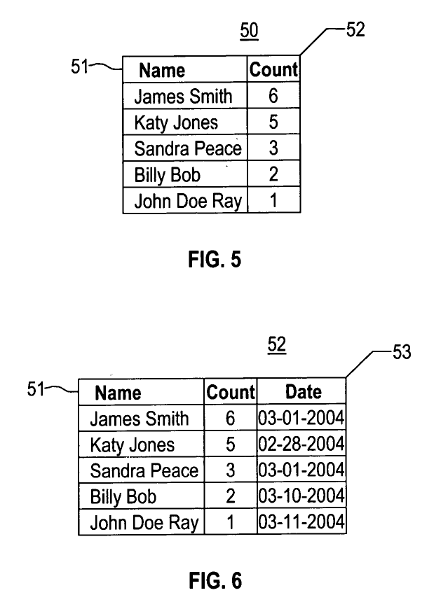

FIG. 5 is an illustration of a set of records corresponding to a set of persons that are included in a buddy list in accordance with one embodiment of the present invention. The buddy list 50 comprises 5 records with each record identifying a person on this list. Field 51 contains the name of the person. Field 52 is a count field that contains the current number transactions for that person. This count field 52 will be an internal field used by the process to sort the entries. Depending on the system design, this field may not be visible to the user. A transaction is anytime the user has contacted that person via the buddy list. In this particular record, the persons listed in descending order according to the number of transactions for that person. As shown, James Smith is listed first because that person currently has the greatest number of transactions.

FIG. 6 is an illustration of a set of records corresponding to a set of persons that are included in a buddy list showing fields for number of accesses and the time of the last access of that person in the list. As shown, this record has an additional field 53, which indicates the time of the last transaction for the person. In this particular record, again the persons are listed in descending order according to the number of transactions for that person. However, the entries in the list can be arranged according to the most recent transaction for a person. In that arrangement, persons would be listed in descending order with the time of the most recent transaction being at the top.

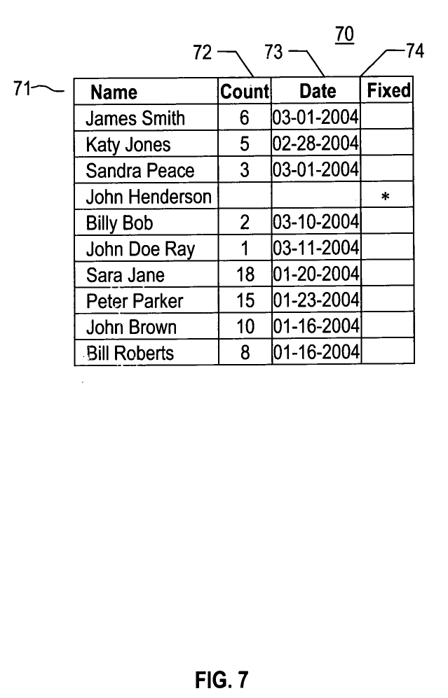

FIG. 7 illustrates a buddy list in accordance with the present invention in which a combination of the transaction count and the date of the last transaction determine the entry order. As shown, this buddy list 70 comprises a set of records. Each record contains a name field 71, a count field 72, a date field 73 and a fixed field 74. As previously mentioned, the count and date fields are used internally to sort the entries. These fields may be visible to the user. This list, in FIG. 7, will also contain two sections. One section will be for active entries in the list. The second will be for inactive entries in the list. The active list represents entries that have at least one transaction within a predetermined period of time. The inactive list will comprise the entries in the last that do not have a transaction within that same predetermined time period.

In FIG. 7, the entries are arranged in an order first by transaction date. This transaction date determines whether an entry will be in the active or inactive list. For example, if the predetermined time period for inclusion on the active is three weeks, then if an entry does not have a transaction within the last three weeks, then that transaction will be moved to the inactive list. Within either the active or inactive lists, the entries are ordered in descending order based on the number of transactions. In the list illustrated in FIG. 7, James Smith has a total of six transactions. The last transaction for James Smith is Mar. 1, 2004. If the three-week range is from Feb. 28, 2004 to Mar. 20, 2004, then the record for James Smith belongs in the active list because the Mar. 1, 2004 date is within that three-week period. However, the record for Sara Jane has 18 transactions, but none of the transactions are within the specified three-week range. As a result of the lack of recent transactions, the Sara Jane entry is in the inactive section of the list. Once the active and inactive portions of the list are established, the entries are arranged by the number of transactions for each entry. The entries are in descending order based on the transaction count. This same concept of ordering entries is the same for the inactive section.

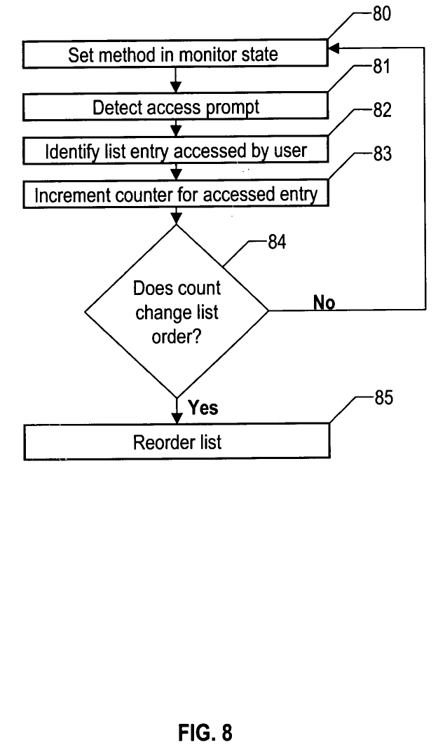

FIG. 8 illustrates a flow diagram of the basic steps in the method of the present invention. After the establishment of the buddy list, the method of the present invention starts out with the method in monitoring state 80. This step monitors the input for access prompts. Once an access prompt is detected in step 81, step 82 identifies the entry in the list that is accessed by the user. After the identification step, the next step 83 is to increment the transaction count for the entry that was accessed by the user. Referring back to FIG. 7, if the user had accessed the Kathy Jones entry, the count field for Kathy Jones would be incremented by one. Following the counter incrementing step, step 84 determines whether the change in the count of the accessed entry changes the order of the entries in the list. In the case where the Sandra Peace entry is incremented from three to four entries, the order would not change. In the case where the order does not change, at this point the method returns to the monitor state 80. In the case where a new transaction to an entry does cause the order of the entries to change, the method moves to step 85 where the reorder process occurs. The method then returns to the monitoring state in step 80.

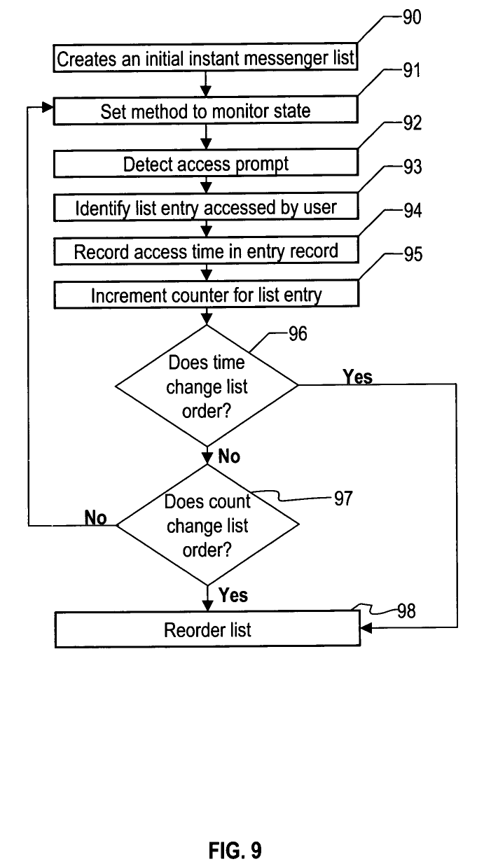

FIG. 9 is an illustration of the steps in an alternate embodiment of the method of the present invention using time and transaction count to order the entries in a buddy list. In step 90, the user creates an initial list of persons. This list can contain one or more entries. In addition, this list creation step can occur at the time the user desires to contact a person. At the completion of this initial step, the method goes into a monitor state in step 91. During this state, the method waits for access attempts of one of the entries in the list. Step 92 detects an access attempt to one of the entries in the list. At this point, step 93 identifies the particular entry accessed by the user. After there has been an identification of the accessed entry, step 94 updates the time access time in the date field of the record for that entry. The time can be as simple as the date of the access. Next, step 95 updates the transaction count for the accessed entry. This transaction count comprises incrementing the current transaction count for that entry by one.

At this point, the user and the person designated by the accessed entry will conduct their communication. The remaining steps 96, 97 and 98 in the method can be implemented during this communication or at the completion of the communication. Step 96 determines whether the update to the date change the list order. Doing this determination the current time (date of the last transaction for that entry before the present access attempt) is examined to determine if this time was in the range for the active entries or for the inactive entries. For example, if the active entry date range is Feb. 28, 2004 through Mar. 20, 2004, the comparison would to determine if the current date of the accessed entry is within this range. If the current date is within this range, the accessed entry is in the active status list. The list order does not change as a result of the implementation of step 96. However, if the current date of the accessed entry was before Feb. 28, 2004, then the accessed entry was in the inactive list. Now this entry will be placed in the active list. The results of step 96 do cause in the active list to change. As a result, the method moves to step 98 where the list is reordered by placing an inactive entry on the active list.

Referring back to step 96, if the determination is that the time update does not result in a reorder of the list, the method moves to step 97. In this step 97, there is a determination of whether the transaction count update changes the order of the entries. Referring back to FIG. 7, if the entry for Sandra Pease was incremented by one from 3 to 4 transactions, that update would not change the order of the entries based on transaction number. As a result, no list reordering would occur. The method would return to the monitor state in step 91. If however, a change in the transaction count of the accessed entry does require a reordering of the entries, the process would perform that reordering in step 98.

Referring back to FIG. 7, there can be a situation when the user accesses an entry from the inactive list. For example, the user accesses the Bill Roberts entry. First, since Bill Roberts was in the inactive list, it is necessary move this entry from the inactive list to the active list. Second, once in the active list, this entry has more cumulative transactions than any other entry in the active list. As part of the reorder step 98, there can be a two-step process determines both when to move an entry from the inactive to the active list and where in the active list to store the entry. This move of entries from inactive to active occurs when the user accesses an inactive entry. As part of the communication between steps 96 and 98, there can a signal within the communication to tell the reorder routine that this reorder is date and transaction number. In this manner, the reorder routine for that two-step process will activate and perform the list reordering. In a situation when only the transaction number causes the reordering, the communication will be between steps 97 and 98. For this case, the reordering process will be a one-step process involving only entries in the active list.

Referring back to FIG. 7, each record contains a fixed field 74. As previously mentioned, in this field, an entry can be designated as fixed to a certain location or slot in the buddy list. This feature enables a user to permanently keep an entry at or near the top of the list. During the methods of FIG. 8 or 9, an additional step in each method can detect whether the accessed entry has a designated fixed location. If the entry does have a fixed location designation in the fixed field, the method would immediately terminate. In addition, as shown in FIG. 5, for entries that have a fixed designation, would not have count or date information in those fields.

It is important to note that while the present invention has been described in the context of a fully functioning data processing system, those skilled in the art will appreciate that the processes of the present invention are capable of being distributed in the form of instructions in a computer readable mediums and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for dynamically ordering entries in an instant messaging list comprising the steps of:
creating an instant messaging list, the entries in the list being ordered in descending order of the number of transactions for each entry in the list;
detecting an attempt to access an entry in an instant messaging list;
identifying the accessed entry;
updating the number of transactions of the accessed entry; and
determining whether to reorder to entries in the instant messaging list based on the updated number of transactions of the accessed entry.

2. The method as described in claim 1 further comprising after said reorder determining step, the step of reordering the entries in the instant messaging list in descending order of the number of transactions for each entry in the list.

3. The method as described in claim 1 wherein said updating step further comprises incrementing the number of transactions by one for an entry when a user accesses that entry.

4. The method as described in claim 1 further comprising before said updating step, the step of determining whether the accessed entry is designated as a fixed entry.

5. The method as described in claim 4 further comprising the step of returning to a monitoring state when the determination is that the accessed entry is designated as a fixed entry.

6. A method for dynamically ordering entries in an instant messaging list comprising the steps of:
creating an instant messaging list, the entries in the list being ordered in descending order based on the most recent transaction for each entry;
detecting an attempt to access an entry in an instant messaging list;
identifying the accessed entry;
updating the time of the most recent transaction for the accessed entry; and
determining whether to reorder the entries in the instant messaging list based on the most recent transaction of each entry in the list.

7. The method as described in claim 6 further comprising after said time updating step, the step of updating the number of transactions for the accessed entry.

8. The method as described in claim 7 further comprising the step of reordering the list of entries when the determination is that the updated time of the most recent transaction of the accessed entry requires reordering to maintain a proper order of the entries.

9. The method as described in claim 8 wherein said reordering step further comprises reordering the entries in the list based on the number of transactions for each entry.

10. The method as described in claim 7 further comprising the step of determining whether to reorder to entries in the instant messaging list based on the updated number of transactions of the accessed entry when the determination is not to reorder the entries based on the most recent transaction of each entry.

11. The method as described in claim 7 wherein said list creating step further comprises creating a record for each entry in the list, the record comprising a set of fields which include a number of transactions field and a time field.

12. The method as described in claim 11 wherein said list creating step further comprising an active section of the list and an inactive section of the list, the active section comprising list entries that have had a transaction within a specified time period.

13. The method as described in claim 6 further comprising before said updating step, the step of determining whether the accessed entry is designated as a fixed entry.

14. The method as described in claim 13 further comprising the step of returning to a monitoring state when the determination is that the accessed entry is designated as a fixed entry.

15. A computer program product in a computer readable medium for dynamically ordering entries in an instant messaging list comprising:
instructions for creating an instant messaging list, the entries in the list being ordered in descending order based on the most recent transaction for each entry;
instructions for detecting an attempt to access an entry in an instant messaging list;
instructions for identifying the accessed entry;
instructions for updating the time of the most recent transaction for the accessed entry; and
instructions for determining whether to reorder the entries in the instant messaging list based on the most recent transaction of each entry in the list.

16. The computer program product as described in claim 15 further comprising after said time updating instructions, instructions for updating the number of transactions for the accessed entry.

17. The computer program product as described in claim 16 further comprising instructions for reordering the list of entries when the determination is that the updated time of the most recent transaction of the accessed entry requires reordering to maintain a proper order of the entries.

18. The computer program product as described in claim 17 wherein said reordering instructions further comprise instructions for reordering the entries in the list based on the number of transactions for each entry.

19. The computer program product as described in claim 16 further comprising instructions for determining whether to reorder to entries in the instant messaging list based on the updated number of transactions of the accessed entry when the determination is not to reorder the entries based on the most recent transaction of each entry.

20. The computer program product as described in claim 16 wherein said list creating instructions further comprise instructions for creating a record for each entry in the list, the record comprising a set of fields which include a number of transactions field and a time field.

21. The method as described in claim 20 wherein said list creating instructions further comprise instructions for creating an active section of the list and an inactive section of the list, the active section comprising list entries that have had a transaction within a specified time period.

22. The computer program product as described in claim 15 further comprising before said updating instructions, instructions for determining whether the accessed entry is designated as a fixed entry.

23. The computer program product as described in claim 22 further comprising instructions for returning to a monitoring state when the determination is that the accessed entry is designated as a fixed entry.
